(19) United States
(12) Patent Application Publication
(10) Pub. No.: US 2024/0281901 A1
(43) Pub. Date: Aug. 22, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: EIJI KAMINO, TOKYO (JP); TAKUMA SUZUKI, TOKYO (JP)

(21) Appl. No.: 18/571,270

(22) PCT Filed: Feb. 17, 2022
(86) PCT No.: PCT/JP2022/006302

§ 371 Date: Dec. 18, 2023

(30) Foreign Application Priority Data
Jun. 25, 2021 (JP) 2021-105444

(51) Int. Cl. G06Q 50/00; H04L 9/32

(52) U.S. Cl. CPC G06Q 50/01; H04L 9/3213

(57) ABSTRACT

The present technology relates to an information processing apparatus, an information processing method, and a program capable of presenting a highly reliable profile in an SNS by using a token having uniqueness. Information of one or more tokens having uniqueness and owned by a user having an account of a social network service is acquired from a blockchain, and setting data to be used for page setting of a page of the user of the social network service is generated, the setting data being setting data for setting the token to be presented on the page of the user of the social network service, among the tokens owned by the user.

### TECHNICAL FIELD

The present technology relates to an information processing apparatus, an information processing method, and a program, and particularly relates to an information processing apparatus, an information processing method, and a program capable of presenting a highly reliable profile (person introduction) in a social networking service (SNS) by using a token having uniqueness.

### BACKGROUND ART

Patent Document 1 describes the technology of recording a transaction history of a non-fungible token (NFT), which is an encrypted asset having uniqueness, by using blockchain.

### CITATION LIST

### Patent Document

Patent Document 1: Japanese Patent No. 6804073

### SUMMARY OF THE INVENTION

### Problems to be Solved by the Invention

For example, in a social network service (SNS) such as Twitter (registered trademark), Facebook (registered trademark), Instagram (registered trademark), or Line (registered trademark), a profile such as the user's name, date of birth, educational background, occupation, or hobby is displayed. However, the profile is less reliable since the user can freely register.

The present technology has been made in view of such a situation, and makes it possible to present a highly reliable profile in an SNS by using a token having uniqueness.

### Solutions to Problems

In an information processing apparatus or a program according to the present technology, the information processing apparatus includes: a data reading unit that acquires information of one or more tokens having uniqueness and owned by a user having an account of a social network service from a blockchain; and a setting data generation unit that generates setting data to be used for page setting of a page of the user of the social network service, the setting data being setting data for setting the token to be presented on the page of the user of the social network service, among the tokens owned by the user, and the program causes a computer to function as the information processing apparatus.

In an information processing method of the present technology, an information processing apparatus includes a data reading unit and a setting data generation unit, and the information processing method includes: the data reading unit acquiring information of one or more tokens having uniqueness and owned by a user having an account of a social network service from a blockchain; and the setting data generation unit generating setting data to be used for page setting of a page of the user of the social network service, the setting data being setting data for setting the token to be presented on the page of the user of the social network service, among the tokens owned by the user.

In an information processing apparatus, an information processing method, and a program of the present technology, information of one or more tokens having uniqueness and owned by a user having an account of a social network service is acquired from a blockchain, and setting data to be used for page setting of a page of the user of the social network service is generated, the setting data being setting data for setting the token to be presented on the page of the user of the social network service, among the tokens owned by the user.

### BRIEF DESCRIPTION OF DRAWINGS

FIG. 1 is a diagram illustrating a profile screen of an SNS created by applying the present technology.

FIG. 2 is a conceptual diagram of an NFT presentation system to which the present technology is applied.

FIG. 3 is a block diagram illustrating a hardware configuration of the NET presentation system.

FIG. 4 is a diagram for explaining a procedure of NFT presentation setting in the SNS.

FIG. 5 is a diagram for explaining a procedure of the NFT presentation setting in the SNS.

FIG. 6 is a diagram for explaining the procedure of the NFT presentation setting in the SNS.

FIG. 7 is a diagram for explaining the procedure of the NFT presentation setting in the SNS.

FIG. 8 is a diagram for explaining the procedure of the NFT presentation setting in the SNS.

FIG. 9 is a diagram illustrating an NFT presented on a screen of a predetermined SNS.

FIG. 10 is a block diagram illustrating a configuration example of hardware of a computer in a case where the computer executes a series of processing by a program.

### MODE FOR CARRYING OUT THE INVENTION

Hereinafter, embodiments of the present technology will be described with reference to the drawings.

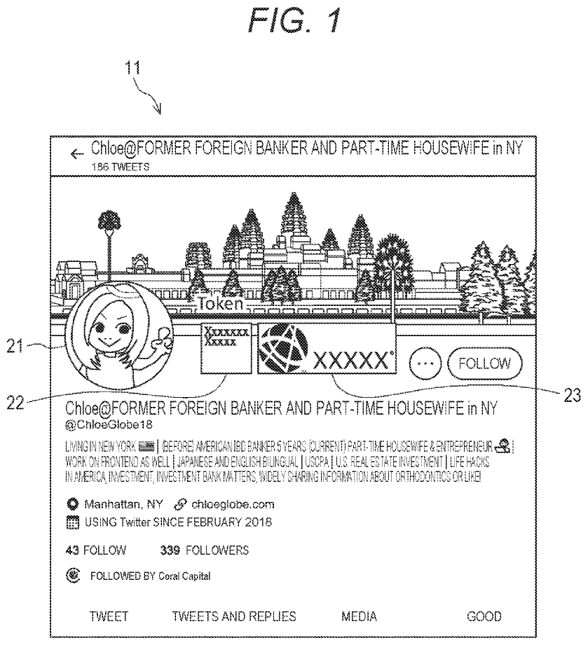

FIG. 1 is a diagram illustrating a profile screen of an SNS created by applying the present technology. In FIG. 1, a profile screen 11 is a screen that is displayed when, for example, a terminal device such as a smartphone is used to access an SNS such as Twitter (registered commercial) of a predetermined user (poster) and display of a profile is selected. Note that, hereinafter, in the case of the user of the SNS, the user is assumed to be a poster (account registrant) of the SNS. On the profile screen 11, a profile image (profile icon) 21 such as a face photograph of the user is displayed, and non-fungible token (NFT) images 22 and 23 associated with the NFT owned by the user are displayed beside the profile image. The NFT images 22 and 23 indicate that the user belongs to an institution such as a company or a school specified from the images (character) or the like, or has acquired the qualification specified from the images. For example, the NFT issued by an institution to which the user belongs only to a person belonging to the institution, the NFT issued by a specific institution only to a person who has acquired a predetermined qualification, or the like can be used as a verifiable credential (VC) that can prove issuance after being approved by the specific institution. For example, the NFT can also be used as a driver's license, a qualification certificate, a degree certificate, an award history, a learning history, a training certificate, a birth certificate, and the like.

Therefore, in the SNS (the page of the user of the SNS), each user can present (disclose) the NFT owned by the user with the NFT image, thereby presenting a highly reliable profile to another user. Furthermore, even in a case where information is posted by using only an account name of which an individual is not specified in the SNS, it is possible to know an institution to which the user belongs and the acquired qualification by the NFT presented on the SNS, and thus, it is possible to determine the reliability of the posted information. For example, in a case where a user for which the NFT issued only to a person having a doctor's license is presented on the SNS has posted medical advice or the like, it can be determined that the reliability of the advice is high even if the advice is anonymous. Note that the NFT image of the NFT that is officially authenticated and the NFT image of the NFT that is not officially authenticated may be displayed simultaneously in a distinguishing manner.

Here, the NET is digital data that is issued and transacted on blockchain and has a role as an anti-counterfeit certificate and a possession certificate. The NFT has non-fungibility (non-substitutable property) and represents (symbolizes) content having uniqueness. The types of content targeted for NFT include general digital items, which are intangible objects, such as files of music, moving images, electronic books, and sentences, and the like. In the present embodiment, the content is an image (NFT image) presented on the SNS.

The NFT is generated on the basis of, for example, an Ethereum Request for Comments (ERC) 721 or an ERC 1155 which is a token standard. As the type of token in which the transaction information is recorded on the blockchain, there is a fungible token (FT) having fungibility such as cryptocurrency (virtual currency), in addition to a token, such as the NFT, which is an encrypted asset having uniqueness. The fungible token is generated, for example, on the basis of an ERC 20 which is a token standard. In the present embodiment, a token that is an encrypted asset having uniqueness is referred to as an NFT. However, the encrypted asset (token) having uniqueness may be other than the NFT.

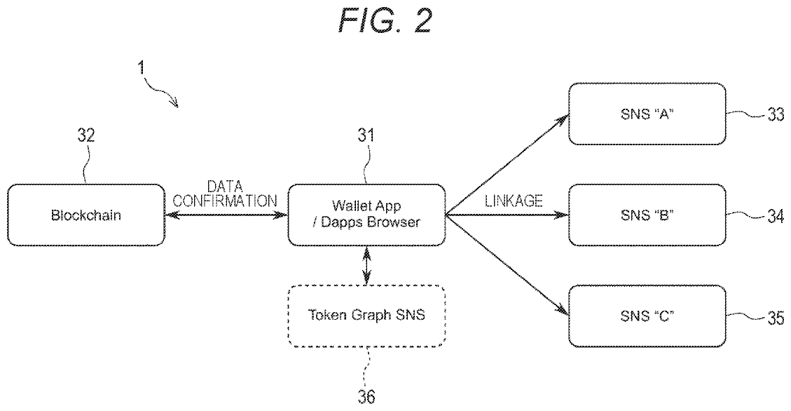

FIG. 2 is a conceptual diagram of an NFT presentation system to which the present technology is applied. In FIG. 2, an NFT presentation system 1 includes a wallet application 31, a blockchain 32, an SNS “A” 33, an SNS “B” 34, an SNS “C” 35, and a token graph SNS 36. The wallet application 31 is an application that can create a wallet and access the created wallet. In the wallet, a wallet address on the blockchain 32 used for transaction of NFT or cryptocurrency, and a secret key and a public key (key pair) are stored and managed. The blockchain 32 is a type of database constructed by a P2P computer network by using a well-known blockchain mechanism. Ethereum and the like are known as existing blockchain. The blockchain 32 records information related to the NFT (ID, owner's address, content metadata, and the like), transaction information (transaction history), and the like.

The wallet application 31 incorporates middleware such as Metamask for accessing dApp (Decentralized-Application) which is an application operating on the blockchain 32. The wallet application 31 logs in to the wallet, acquires the wallet address, and acquires the information of the NTF associated with the wallet address from the dApp. Therefore, the wallet application 31 can acquire the NFT owned by the user from the wallet (blockchain 32).

The wallet application 31 is a Dapps browser having a function as a browser application for browsing a website and a function of accessing the dApp. The wallet application 31 can log in to the SNS for which the user has an account by the function as a browser application. In FIG. 2, there are three types of SNSs for which the user has accounts: the SNS “A” 33, the SNS “B” 34, and the SNS “C” 35 with names of “A”, “B”, and “C”. However, the number of SNSs for which the user has accounts is not limited to three, and the number of SNSs for which wallet application 31 can log in is not limited to three. As the type of SNS, Twitter (registered trademark), Facebook (registered trademark), Instagram (registered trademark), Line (registered trademark), and the like are well known.

By individually logging in to each of the SNS “A” 33, the SNS “B” 34, and the SNS “C” 35, the wallet application 31 can access an account management page of each of the SNS “A” 33, the SNS “B” 34, and the SNS “C” 35 and display the account management page on the wallet application 31. The wallet is linked to the SNS logged in by the wallet application 31, and the information of the NFT obtained from the wallet is sent to the SNS. The user sets an NFT to be presented (disclosed) on the SNS from among the NFTs owned by the user on the account management page.

The SNS “A” 33, the SNS “B” 34, and the SNS “C” 35 cause the NFT image associated with the NFT to be displayed on the screen of the SNS according to the content set in each account management page. The NFT image may be arranged in the vicinity (for example, the side) of the profile image (profile icon) 21 as illustrated in FIG. 1, or may be arranged in another portion such as the upper portion or the lower portion of the page (screen).

Note that the wallet application 31 may set the NFT to be presented on each SNS by the user's operation on the setting screen generated by the wallet application 31 without logging in to the SNS (or even when logging in). In this case, the wallet application 31 logs in each SNS and reflects the setting content (setting data) set on the setting screen.

The token graph SNS 33 acquires information of the NFT owned by the user from the wallet application 31. The token graph SNS 33 similarly acquires NFT information from many users. The token graph SNS 33 analyzes the preference and the like of each user from the collected NFT information, and presents an advertisement or recommendation suitable for the preference of each user to each user through the wallet application 31 on the basis of the result. For example, connection (such as becoming a follower of the SNS) is recommended to users having similar preference, users having the same NFT, users having the NFT of a specific artist, or users having a predetermined number or more of NFTs owned by fans of a specific artist.

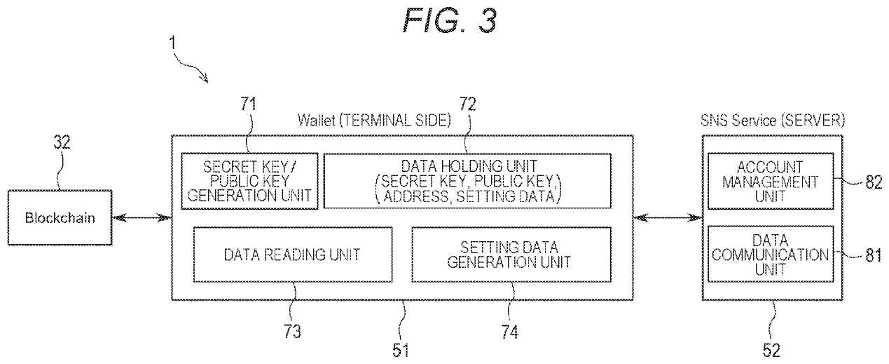

FIG. 3 is a block diagram illustrating a hardware configuration of the NFT presentation system 1. In FIG. 3, the NFT presentation system 1 includes the blockchain 32, a terminal device 51, and a server 52. The blockchain 32, the terminal device 51, and the server 52 are connected to be communicable with each other.

The blockchain 32 is similar to that in FIG. 2, and thus description thereof is omitted.

The terminal device 51 is a terminal on which the wallet application 32 of FIG. 2 operates. When the wallet application 32 is activated, the terminal device 51 executes the processing of the wallet application 32 described in FIG. 2. The terminal device 51 has a secret key/public key generation unit 71, a data holding unit 72, a data reading unit 73, and a setting data generation unit 74 as processing units constructed by the processing of the wallet application 32.

The secret key/public key generation unit 71 generates a secret key and a public key necessary for transaction of the encrypted asset when creating a wallet for managing the encrypted asset (NFT and cryptocurrency) of the blockchain 31. The secret key/public key generation unit 71 generates a wallet address on the basis of the public key. The secret key, the public key, and the wallet address generated by the secret key/public key generation unit 71 are supplied to the data holding unit 72.

The data holding unit 72 saves (stores) the secret key, the public key, and the wallet address from the secret key/public key generation unit 71. The data holding unit 72 stores the setting data supplied from the setting data generation unit 74. The setting data indicates the setting of the NFT to be presented on each SNS.

The data reading unit 73 acquires the information of the NFT (the NFT owned by the user) associated with the wallet address saved in the data holding unit 72 from the blockchain 32, and transmits the information to the server 52 of the SNS logged in by the terminal device 51.

The setting data generation unit 74 acquires the setting of the NFT presented on each SNS from the server 2 of each SNS. Alternatively, when the setting of the NFT to be presented on each SNS is performed by the user's operation on the terminal device 51, the setting is acquired. The setting data generation unit 74 generates setting data indicating the acquired setting contents for every SNS, supplies the setting data to the data holding unit 72, and causes the setting data to be saved therein. Note that the setting data generation unit 74 may acquire the NFT information from the data reading unit 73 and set a condition regarding NFT presentation, such as the NFT to be presented on each SNS and the like, on the basis of the user's operation. In this case, setting data indicating contents set for each SNS is generated and transmitted to the server 52 of every SNS. The server 52 (account management unit 82) of each SNS sets the NFT and the like to be presented on the SNS according to the setting data transmitted from setting data generation unit 74. That is, the server 52 (account management unit 82) of each SNS performs page setting regarding the NFT presentation such as which NFT among the NFTs owned by the user is presented on the page of the user of the SNS on the basis of the setting data from the setting data generation unit 74.

In the wallet, there is a case where a terminal operation, such as a web wallet which provides a service of the wallet on the web, which is operated by a user and a device which manages the wallet are separate devices. Therefore, any one or more processing units among the secret key/public key generation unit 71, the data holding unit 72, the data reading unit 73, and the setting data generation unit 74 may be implemented in a device different from the terminal device 51 operated by the user.

The server 52 is a server which provides an SNS service. It is assumed that the server 52 is a server which provides a service of an arbitrary SNS among the SNSs for which the user has accounts. The server 52 has a data communication unit 81 and the account management unit 82.

The data communication unit 81 acquires the information of the NFT owned by the user by communication, the information being acquired by the data reading unit 73 of the terminal device 51. The data communication unit 81 supplies the acquired setting data to the account management unit 82.

The account management unit 82 sets a condition regarding NFT presentation, such as the NFT to be presented on the SNS, on the basis of the information of the NFT from the data communication unit 81 and the user's operation on the account management page (account management screen) displayed on the wallet application of the terminal device 51. The account management unit 82 performs setting such that an image (NFT image) of the NTF set to be presented on the SNS is displayed at a predetermined position on the screen of the SNS of the account of the user.

### Preliminary Preparation

In order to enable the terminal device 51 to perform NFT presentation setting in each SNS, preliminary preparation is performed as follows.
1. A wallet (MetaMask) or the like for managing an encrypted asset is installed in the terminal device 51.
2. A key pair of a secret key and a public key necessary for the transaction of the encrypted asset in the blockchain 32 is generated.
3. Generate a backup of the secret key.
4. Generate a wallet address.
5. Use the encrypted asset to purchase an NFT.

Note that when an NFT marketplace such as Opensea is registered, a plurality of NFTs registered in the NFT marketplace is displayed in a wallet. In the case of a single service such as Cryptokitties, a plurality of NFTs included in the service is registered and displayed in the wallet.

### <NFT Presentation Setting Procedure>

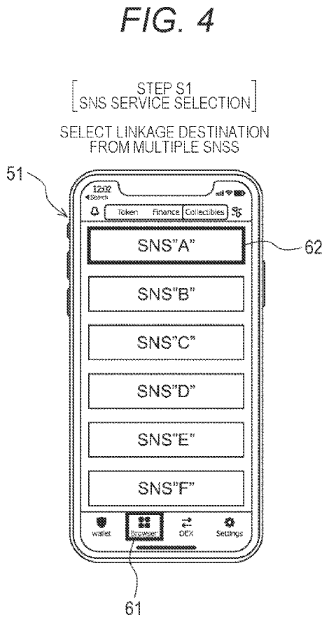

Hereinafter, a setting procedure of NFT presentation on the SNS will be described with reference to FIGS. 4 to 8. Note that the terminal device 51 has a display with a touch panel, and a selection operation is performed by the user's touch operation.

When the user activates the wallet application 31 on the terminal device 51, an initial screen (SNS list screen) of FIG. 4 showing the procedure of step S1 is displayed on the screen (display) of the terminal device 51. In the SNS list screen of FIG. 4, a list (SNS “A” to SNS “F”) of the SNS is displayed. The SNS list screen may include an SNS for which the user does not have an account. When the user touches a browser icon 61 at the bottom of the SNS list screen, the wallet application 31 logs in to the wallet. The user selects an SNS (an SNS to be linked with the wallet) on which the client terminal presentation setting is performed. It is assumed that the user touches a display area 62 of the SNS “A”. As a result, the wallet application 31 logs in to the SNS “A”. Note that the user may log in to the wallet after logging in to the SNS.

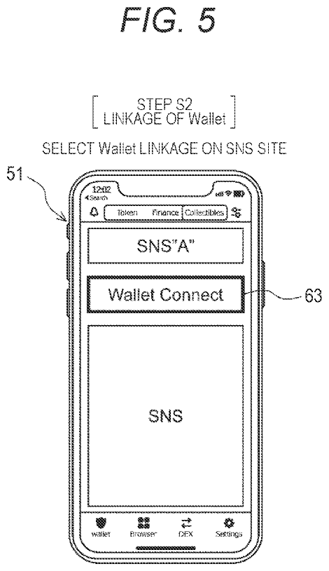

When the wallet application 31 logs in to the SNS “A”, an account management screen of the SNS “A” of FIG. 5 showing the procedure of step S2 is displayed on the display. The account management screen of FIG. 5 is a screen provided by the server 52 of the SNS “A”. However, the account management screen may be generated by the setting data generation unit 74 of the terminal device 51.

The user touches a wallet connect selection area 63 on the account management screen of FIG. 5. Therefore, the SNS “A” and the wallet are linked with each other, and the information of the wallet can be transmitted to the SNS “A”. Specifically, the wallet address saved in the data holding unit 72 of FIG. 3 is transmitted to the server 52 of the SNS “A”.

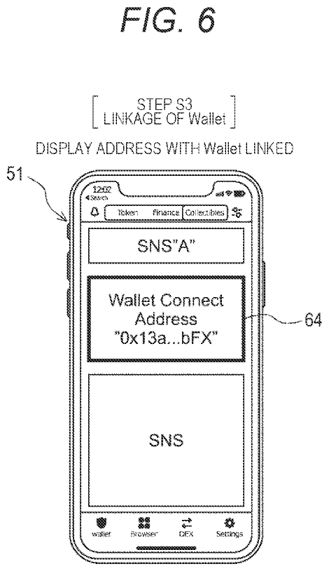

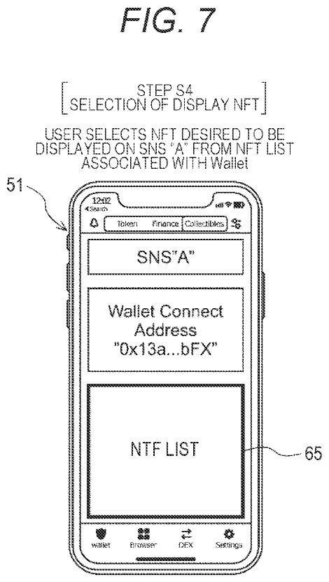

When the SNS “A” and the wallet are linked with each other, the account management screen of FIG. 6 showing the procedure of step S3 is displayed on the display. The wallet address is displayed in a display area 64 of the account management screen of FIG. 6. When the user touches the display area 64, the wallet application 31 acquires the information of the NET (the NFT owned by the user) associated with the wallet address from the blockchain 32 and transmits the information to the server 52 of the SNS “A”. Therefore, the account management screen of FIG. 7 showing the procedure of step S4 is displayed on the display. In the display area 65 of the account management screen of FIG. 7, the list of the NFTs owned by the user is displayed. The user selects one or more NFTs to be presented on the SNS “A” from the list of the NFTs displayed on the display area 65. In a case where no NFT is presented on the SNS “A”, the user does not select any NFT. When the NET presentation setting in the SNS “A” is completed, the screen returns to the SNS list screen in FIG. 4. The user can perform the NFT presentation setting by performing an operation similar to that in steps S1 (FIG. 4) to S4 (FIG. 7) on another SNS.

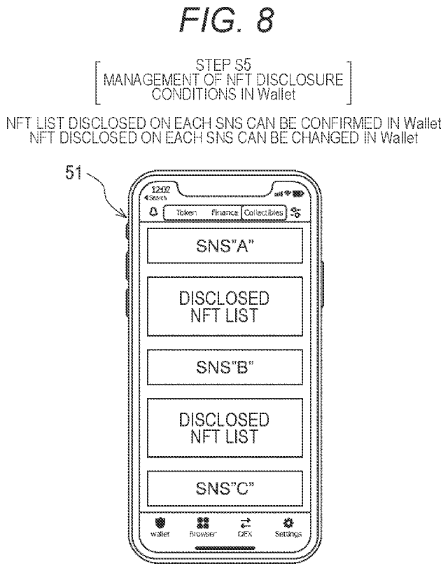

When the user selects the display of the management screen by a predetermined operation in a case where the NFT presentation setting of all the SNSs for which the user has accounts is performed, the management screen of FIG. 8 showing the procedure of step S5 is displayed on the display. The management screen of FIG. 8 displays a list of NFTs to be presented on each SNS and the like. With such a management screen, the user can confirm setting regarding the presentation of the NFT in each SNS (NFT disclosure conditions and the like). In a case where it is desired to correct the NFT presentation setting, by touching the display area of the SNS to be corrected, it is possible to shift to the operation of the account management screen in step S2 (FIG. 5) and perform correction.

Note that the disclosure range of the NFT to be presented (disclosed) on each SNS (restriction of viewers to whom the NET is presented) may be set by the wallet application 31 or the server 52 (account management unit 82) of each SNS. For example, the NFTs owned by users are grouped, and viewers are classified by attributes. Examples of the viewer's attribute include age, sex, residential area, and relationship (relatives, friends, same community members, followers of own SNS, and the like) with the SNS poster. In this case, the disclosure range of the NFT may be set, for example, such that the NFT belonging to a group A is disclosed to friends, the NFT belonging to a group B is disclosed only to same community members, and the NFT belonging to a group C is disclosed to all viewers.

The wallet application 31 or the server 52 (account management unit 82) of each SNS may enable the user to select the type of NFT to be presented (disclosed) in each SNS, or may enable the user to select the type of NFT to be presented (disclosed) in each SNS for each type of SNS (according to the type of each SNS). The wallet application 31 or the server 52 (account management unit 82) of each SNS may automatically set, for each type of SNS (according to the type of each SNS), the NFT to be presented (disclosed) in each SNS on the basis of the type of NFT and the like. For example, a biz-based SNS such as LinkedIn displays a biz-based NFT, and a hobby-based SNS such as Instagram presents a hobby-based NFT. According to this, it is possible to appropriately present the NFT according to the type of the SNS, and the effort of setting the NFT to be presented is also reduced.

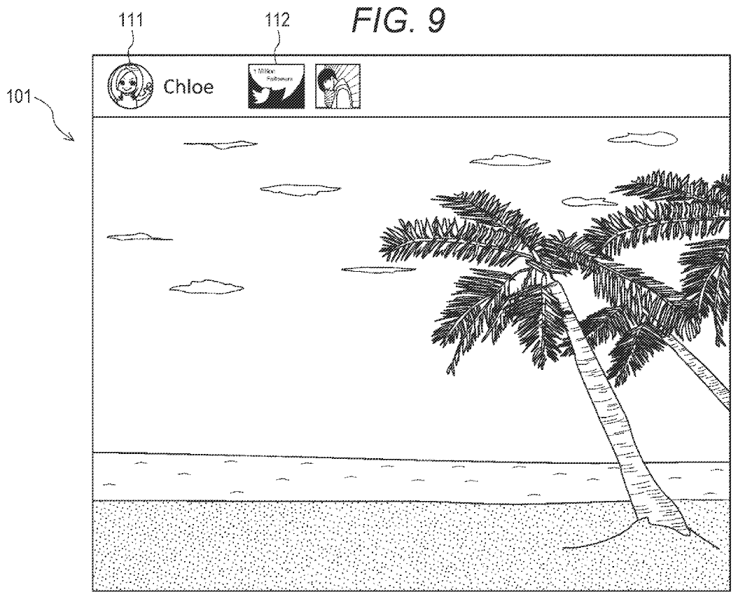

FIG. 9 is a diagram illustrating an NFT presented on a screen of a predetermined SNS. In FIG. 9, a profile image 111 is displayed on upper left of an SNS screen 101. An NFT image 112 of the NFT owned by the poster of the SNS (first SNS) is displayed on the right side of the profile image 111.

The NFT image 112 is an NFT issued to the poster when the number of followers reaches, for example, 10,000 in another SNS (second SNS). The poster owning such an NFT is proved to be highly popular. Note that, in a case where the poster who has acquired such an NFT in the second SNS moves to the first SNS, any benefit may be received from the first SNS.

### <Program>

A series of processing in the NET presentation system 1, the terminal device 51, or the server 52 described above can be executed by hardware or also executed by software. In a case where a series of processing is executed by the software, a program constituting the software is installed on a computer. Here, the computer includes a computer incorporated in dedicated hardware, a general-purpose personal computer capable of executing various functions by installing various programs, and the like, for example.

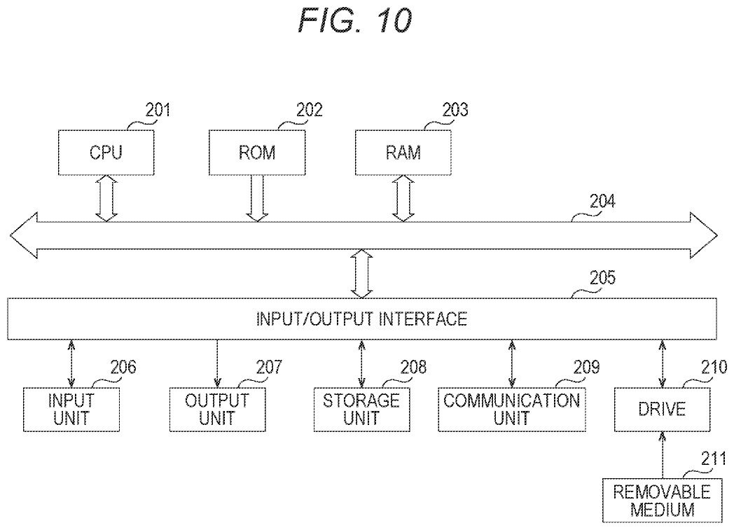

FIG. 10 is a block diagram illustrating a configuration example of hardware of a computer in a case where the computer executes each processing executed by the NFT presentation system 1, the terminal device 51, or the server 52, in accordance with a program.

In the computer, a central processing unit (CPU) 201, a read only memory (ROM) 202, and a random access memory (RAM) 203 are connected to each other by a bus 204.

An input/output interface 205 is further connected to the bus 204. The input/output interface 205 is connected to an input unit 206, an output unit 207, a storage unit 208, a communication unit 209, and a drive 210.

The input unit 206 includes a keyboard, a mouse, a microphone, and the like. The output unit 207 includes a display, a speaker, and the like. The storage unit 208 includes a hard disk, a non-volatile memory, and the like. The communication unit 209 includes a network interface and the like. The drive 210 drives a removable medium 211 such as a magnetic disk, an optical disk, a magnetooptical disk, or a semiconductor memory.

In the computer configured as described above, for example, the CPU 201 loads the program stored in the storage unit 208 into the RAM 203 via the input/output interface 205 and the bus 204 and executes the program, to thereby perform the above-described series of processes.

The program executed by the computer (CPU 201) can be provided by being recorded on the removable medium 211 as a package medium or the like, for example. Furthermore, the program can be provided via a wired or wireless transmission medium such as a local area network, the Internet, or digital satellite broadcasting.

In the computer, installation of the program on the storage unit 208 via the input/output interface 205 can be achieved by insertion of the removable medium 211 into the drive 210. Furthermore, installation of the program on the storage unit 208 can be achieved by reception of the program at the communication unit 209 via a wired or wireless transmission medium. Additionally, the program may be installed in advance on the ROM 202 and the storage unit 208.

Note that the program executed by the computer may be a program for processing in time series in the order described in the present description, or a program for processing in parallel or at a necessary timing such as when a call is made.

The present technology can also have the following configurations.

(1)

An information processing apparatus including:
a data reading unit that acquires information of one or more tokens having uniqueness and owned by a user having an account of a social network service from a blockchain; and
a setting data generation unit that generates setting data to be used for page setting of a page of the user of the social network service, the setting data being setting data for setting the token to be presented on the page of the user of the social network service, among the tokens owned by the user.
   (2)

The information processing apparatus according to (1), in which
the setting data generation unit sets a condition for presenting the token owned by the user on the page of the user of the social network service.
   (3)

The information processing apparatus according to (1) or (2), in which
the setting data generation unit restricts a viewer to which the token owned by the user is presented on the page of the user of the social network service.
   (4)

The information processing apparatus according to any one of (1) to (3), in which
the setting data generation unit generates the setting data for each of a plurality of the social network services for which the user has accounts.
   (5)

The information processing apparatus according to any one of (1) to (4), in which
the setting data generation unit sets a type of the token to be presented on the social network service according to a type of the social network service.
   (6)

The information processing apparatus according to (5), in which
the setting data generation unit sets the type of the token to be presented on the social network service on the basis of selection of the user.
   (7)

The information processing apparatus according to any one of (1) to (6), further including:
a processing unit that performs advertisement or recommendation on the basis of the user's preference analyzed on the basis of the token owned by the user.
   (8)

The information processing apparatus according to (7), in which
the processing unit recommends a connection with another user having similar preference to that of the user.
   (9)

The information processing apparatus according to (7), in which
the processing unit recommends a connection with another user having the same token as the token owned by the user.
   (10)

The information processing apparatus according to any one of (1) to (9), in which
an image associated with the token is displayed next to a profile icon of the user on the page of the user of the social network service.
   (11)

The information processing apparatus according to any one of (1) to (10), in which
an image associated with the token which is officially authenticated and an image associated with the token which is not officially authenticated are simultaneously displayed on the page of the user of the social network service.
   (12)

An information processing method, in which
an information processing apparatus includes a data reading unit and a setting data generation unit, the method including:
the data reading unit acquiring information of one or more tokens having uniqueness and owned by a user having an account of a social network service from a blockchain; and
the setting data generation unit generating setting data to be used for page setting of a page of the user of the social network service, the setting data being setting data for setting the token to be presented on the page of the user of the social network service, among the tokens owned by the user.
   (13)

A program for causing a computer to function as:
a data reading unit that acquires information of one or more tokens having uniqueness and owned by a user having an account of a social network service from a blockchain; and
a setting data generation unit that generates setting data to be used for page setting of a page of the user of the social network service, the setting data being setting data for setting the token to be presented on the page of the user of the social network service, among the tokens owned by the user.

### REFERENCE SIGNS LIST

1 NFT presentation system
31 Wallet application
32 Blockchain
33 SNS
36 Token graph SNS
51 Terminal device
52 Server
71 Secret key/public key generation unit
72 Data holding unit
73 Data reading unit
74 Setting data generation unit

1. An information processing apparatus comprising:
a data reading unit that acquires information of one or more tokens having uniqueness and owned by a user having an account of a social network service from a blockchain; and
a setting data generation unit that generates setting data to be used for page setting of a page of the user of the social network service, the setting data being setting data for setting the token to be presented on the page of the user of the social network service, among the tokens owned by the user.

2. The information processing apparatus according to claim 1, wherein
the setting data generation unit sets a condition for presenting the token owned by the user on the page of the user of the social network service.

3. The information processing apparatus according to claim 1, wherein
the setting data generation unit restricts a viewer to which the token owned by the user is presented on the page of the user of the social network service.

4. The information processing apparatus according to claim 1, wherein
the setting data generation unit generates the setting data for each of a plurality of the social network services for which the user has accounts.

5. The information processing apparatus according to claim 1, wherein
the setting data generation unit sets a type of the token to be presented on the social network service according to a type of the social network service.

6. The information processing apparatus according to claim 5, wherein
the setting data generation unit sets the type of the token to be presented on the social network service on a basis of selection of the user.

7. The information processing apparatus according to claim 1, further comprising:
a processing unit that performs advertisement or recommendation on a basis of the user's preference analyzed on a basis of the token owned by the user.

8. The information processing apparatus according to claim 7, wherein
the processing unit recommends a connection with another user having similar preference to that of the user.

9. The information processing apparatus according to claim 7, wherein
the processing unit recommends a connection with another user having same token as the token owned by the user.

10. The information processing apparatus according to claim 1, wherein
an image associated with the token is displayed next to a profile icon of the user on the page of the user of the social network service.

11. The information processing apparatus according to claim 1, wherein
an image associated with the token which is officially authenticated and an image associated with the token which is not officially authenticated are simultaneously displayed on the page of the user of the social network service.

12. An information processing method, wherein
an information processing apparatus includes a data reading unit and a setting data generation unit, the method comprising:
the data reading unit acquiring information of one or more tokens having uniqueness and owned by a user having an account of a social network service from a blockchain; and
the setting data generation unit generating setting data to be used for page setting of a page of the user of the social network service, the setting data being setting data for setting the token to be presented on the page of the user of the social network service, among the tokens owned by the user.

13. A program for causing a computer to function as:
a data reading unit that acquires information of one or more tokens having uniqueness and owned by a user having an account of a social network service from a blockchain; and
a setting data generation unit that generates setting data to be used for page setting of a page of the user of the social network service, the setting data being setting data for setting the token to be presented on the page of the user of the social network service, among the tokens owned by the user.
